(19) United States
(12) Patent Application Publication
(10) Pub. No.: US 2021/0396639 A1
(43) Pub. Date: Dec. 23, 2021

(54) SENSOR FOR PARTICLE DETECTION

(71) Applicant: 3M INNOVATIVE PROPERTIES COMPANY, St. Paul, MN (US)

(72) Inventors: Michael A. Meis, Cushing, MN (US); Brian D. Gale, Blaine, MN (US)

(21) Appl. No.: 17/296,578

(22) PCT Filed: Nov. 25, 2019
(86) PCT No.: PCT/IB2019/060121

§ 371 Date: May 25, 2021

Related U.S. Application Data
(60) Provisional application No. 62/773,826, filed on Nov. 30, 2018.

(51) Int. Cl. G01N 15/02; G01N 15/06

(52) U.S. Cl. CPC G01N 15/0211; G01N 2015/0046; G01N 15/06

(57) ABSTRACT

The present disclosure describes devices for detecting fine and ultrafine particulate matter. The devices may include at least one optical sensor configured at an angle of greater than 90 degrees from a direction of air flow, such that particulate matter is carried away from the sensor. In some examples, a device includes a housing, a light source and a light trap. The light source may be disposed within the proximal end of the housing and can be configured to direct a beam of light toward the distal end of the housing. The light trap may be disposed within the housing to reduce backscatter from the beam of light.

### TECHNICAL FIELD

The present disclosure generally relates to the field of air quality monitoring.

### BACKGROUND

The suspension of fumes, dust, smoke, gases, fly ash, soot, smoke, aerosols, fumes, mists, condensing vapors, or other contaminants in air constitute particular matter (PM) that alters the air quality of the affected environment. PM-related contamination can be hazardous or harmful to the health of humans, animals, or plants in the environment. As the particle sizes of PM get smaller and smaller, the type and magnitude of health hazards presented become more worrisome. Below certain thresholds, PM particle size can be termed as being “ultrafine” and may present the increased health hazards associated with decreased PM particle sizes. Year over year, an increasing number of deaths and incidences of disease are being attributed to air quality.

### SUMMARY

The present disclosure describes systems for monitoring air quality in an environment and sharing data about the air quality data over a communications network. For example, one or more PM sensors may be deployed in a closed environment, such as a home, a place of business, a childcare facility, an educational institution, or various other locations. The sensor(s) of this disclosure are implemented using enhanced designs that reduce false positives caused by light backscatter (also referred to herein as “noise”) and/or reduce particulate blockage of sensing surfaces. The connected safety technology of this disclosure avails of cloud computing and mobile device access to notify users of air quality conditions that might warrant attention or alternatively, to automatically implement one or more remediation measures to mitigate or rectify the detected air quality issue(s).

The present disclosure also describes devices for detecting fine and ultrafine particulate matter. In some examples, a device includes (at least one optical sensor configured at an angle of greater than 90 degrees from the direction of air flow, such that particulate matter is carried away from the sensor). In some examples, a device includes a housing, a light source and a light trap. In some such examples, the light source is disposed within the proximal end of the housing and is configured to direct a beam of light toward the distal end of the housing. The light trap is disposed within the housing to reduce backscatter from the beam of light.

In one example, this disclosure is directed to an air quality monitoring system. The air quality monitoring system includes an interface, a memory in communication with the interface, and processing circuitry in communication with the memory. The interface is configured to receive air quality information associated with an environment. The memory is configured to store the air quality information associated with the environment. The processing circuitry is configured to detect, based on one or more transitions in the air quality information associated with the environment, an air quality event at the environment. The processing circuitry is further configured to output, via the interface, to an external device, a notification associated with the detected air quality event at the environment.

In another example, this disclosure is directed to a method of monitoring air quality. The method includes receiving air quality information associated with an environment. The method further includes detecting, based on one or more transitions in the air quality information associated with the environment, an air quality event at the environment. The method further includes outputting, to an external device, a notification associated with the detected air quality event at the environment.

In another example this disclosure is directed to a device. The device includes a housing comprising a proximal end and a distal end, where the housing defines a longitudinal axis from the proximal end to the distal end. The device further includes a light source disposed near the proximal end of the housing configured to emit a beam of light along the longitudinal axis toward the distal end of the housing, and a fan configured to move air through the housing in a direction substantially opposite to the longitudinal. The device further includes at least one optical sensor attached to the housing and configured to detect scattered light from the beam of light, wherein the at least one optical sensor is oriented to detect the scattered light at a first angle of less than 90 degrees from the longitudinal axis.

In another example this disclosure is directed to a device. The device includes a housing having a distal end and a proximal end, and a light source disposed within the proximal end of the housing configured to direct a beam of light toward the distal end of the housing. The device further includes a fan configured to draw air through the housing, at least one optical sensor attached to the housing and configured to detect scattered light from the beam of light, and a light trap disposed at the distal end of the housing.

In this way, the systems of this disclosure provide improved air quality sensor hardware that can be deployed in various environments to detect PM contamination characteristics. Moreover, the systems of this disclosure leverage the ongoing air quality monitoring provided by the sensor(s) to inform users of air quality conditions that might need attention, to automatically implement remediation, and/or to log past air quality metrics to form heuristic data for future reference and use.

The details of one or more examples of the disclosure are set forth in the accompanying drawings and in the description below. Other features, objects, and advantages of the disclosure will be apparent from the description and drawings, and from the claims.

### BRIEF DESCRIPTION OF THE DRAWINGS

FIG. 1 is a block diagram illustrating a system that includes an air quality monitoring system (AQMS) for monitoring air quality of environments, in accordance with various aspects of this disclosure.

FIG. 2 is a conceptual diagram illustrating a data flow according to which the AQMS processes information about the air quality of an environment and provide monitoring and alert information to remote users.

FIG. 3 is a graph illustrating a time window that the AQMS may use to define an air quality “episode.”

FIG. 4 is a graph illustrating an example of air quality categorization that the AQMS may implement, in accordance with aspects of this disclosure.

FIG. 5 is a graph illustrating an air quality event that is detected based on recurrence.

FIG. 6 is a graph illustrating another air quality event that is detected based on recurrence.

FIG. 7 is a graph illustrating another air quality event that is detected based on recurrence.

FIG. 8 is a graph illustrating another air quality event that is detected based on air quality fluctuation.

FIG. 9 is a graph illustrating another air quality event that is detected based on persistence.

FIG. 10 is a block diagram providing an operating perspective of the AQMS when hosted as a cloud-based platform capable of supporting multiple, distinct work environments equipped with sensors, in accordance with various techniques of this disclosure.

FIG. 11 is a cross-sectional diagram depicting a particle detector, in accordance with some examples of this disclosure.

FIG. 12 is an exploded view depicting a particle detector, in accordance with some examples of this disclosure.

FIG. 13 is an overhead view depicting a particle detector, in accordance with some examples of this disclosure.

FIG. 14 is an overhead view depicting a particle detector, in accordance with some examples of this disclosure.

FIG. 15 is a flowchart illustrating a process that the AQMS may perform in accordance with aspects of this disclosure.

FIG. 16 is a flowchart illustrating a process that the sensors of this disclosure and/or processing circuitry thereof or coupled thereto may perform in accordance with aspects of this disclosure.

FIG. 17 is a tree diagram illustrating various actions that the AQMS may implement based on the air quality level at environments 8.

### DETAILED DESCRIPTION

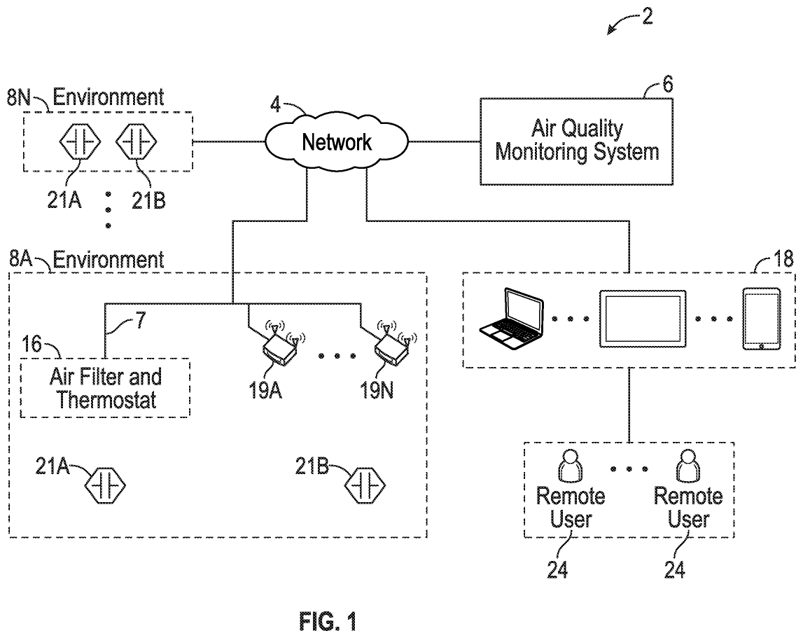

FIG. 1 is a block diagram illustrating a system 2 that includes an air quality monitoring system (AQMS) 6 for monitoring air quality of environments 8A-8N (collectively, “environments 8”), in accordance with various aspects of this disclosure. System 2 is one non-limiting example of an implementation of the systems of this disclosure, and it will be appreciated that the systems of this disclosure are compatible with numerous other implementations. AQMS 6 uses the enhanced PM sensors of this disclosure to obtain air quality metrics of environments 8, and leverages cloud computing technology to provide information about safety events, potential health hazards, or any other air quality-related information relating to environments 8 to remote users 24 via remote computing devices 18.

FIG. 1 is described by way of the example of environment 8A, which is one of environments 8. Environments 8 may include various types of enclosed, partially enclosed, or open spaces, such as a residence, a childcare facility, an educational institution (e.g., one of several buildings thereof), a place of business, a workplace, a greenhouse, a vertical farm, or any other space in which the local air quality might affect the health or wellbeing of people, animals, or plants. As a non-limiting example, FIG. 1 is described with respect to environment 8A, which represents a residence that is left unattended on a regular basis, while the occupants are at work, school, etc. It will be appreciated that PM can have non-health implications as well, such as fouling equipment or electrical components (e.g., HVAC equipment). PM-related contamination also poses a nuisance threat to certain machinery and equipment (e.g., HVAC systems, engines, breathing apparatuses, etc.).

In general, AQMS 6 provides data acquisition, monitoring, activity logging, reporting, predictive analytics, alert generation, and optionally, maintenance with respect to environment 8A. Environment 8A is equipped with PM sensors 21A and 21B (“sensors 21”) in the example of FIG. 1. While the particular example of FIG. 1 illustrates environment 8A being equipped with two sensors, it will be appreciated that environment 8A may be equipped with varying numbers of sensors in accordance with aspects of this disclosure. Sensors 21 may be implemented according to certain enhanced designs of this disclosure, such designs that enable sensors 21 to improve PM detection accuracy by reducing light contamination caused by backscatter, and/or by directing airflow of the collected sample(s) away from the sensing surface(s) of the respective sensor 21.

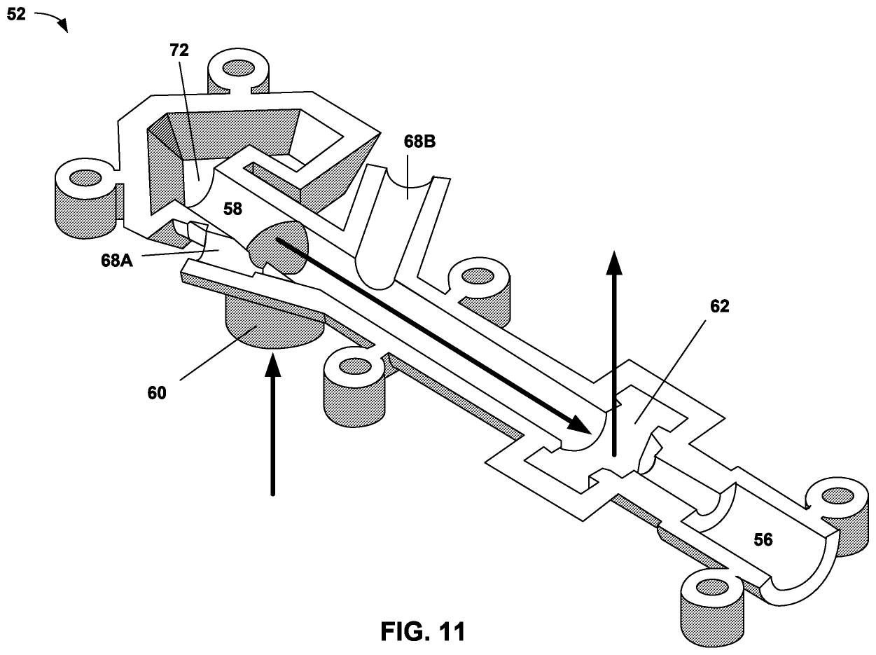

In some examples, sensor 21A and sensor 21B are configured or designed to detect PM of differing particle sizes. For instance, sensor 21A may be configured to detect PM of greater particle sizes than the particle sizes of PM for which sensor 21B is configured. In some implementations, both of sensors 21A and 21B may be integrated into a single device or system, such as in the examples illustrated in one or more of FIGS. 11-14 and described below in greater detail.

Environment 8A is also equipped with a plurality of wireless access points 19A-19N (collectively, “wireless access points 19”) that may be geographically distributed throughout environment 8A to provide support for wireless communications throughout work environment 8B. Wireless access points 19 also enable communication devices positioned with environment 8A to communicate with devices positioned outside of environment 8A. Each of sensors 21 is configured to communicate data, such as PM measurements and other air quality information obtained with respect to the air of environment 8A via wireless access points 19 according to wireless communication protocols, such as Wi-Fi® (implemented according to the IEEE 802.11 family of standards), Bluetooth®, or the like. As such, each of sensors 21 may provide stream of data about the air quality within environment 8A to wireless access points 19.

Wireless access points 19 may form a portion of one or more routers, or may otherwise be coupled to one or more routers. The router(s) are not shown separately in FIG. 1 for ease of illustration purposes. Via the one or more router(s), wireless access points 19 may provide the air quality information streamed by sensors 21 to AQMS 6, over network 4. Network 4 may be implemented as part of a packet-based network, such as a local area network (LAN), a wide area network (WAN), or a global network such as the Internet. Said another way, AQMS 6 is configured to obtain information describing the air quality of environments 8.

Sensors 21 may be equipped with logic circuitry (e.g., discrete logic circuitry and/or integrated logic circuitry), microprocessors or processing circuitry (e.g., fixed function circuitry and/or programmable processing circuitry), DSPs, ASICs, FPGAs, or equivalent devices or circuitry. These components of sensors 21 may analyze the air quality information within environment 8A to make various determinations. In some examples, sensors 21 may be coupled to one or more devices, such as a communication hub (not shown in FIG. 1) that implements logic to analyze the air quality information provided by sensors 21 to make these determinations. In either implementation, the logic circuitry included in or coupled to sensors 21 may determine various courses of action based on the air quality information, such as a rate at which to stream or “push” the information over network 4 to AQMS 6. For ease of discussion, the description below is based on the example implementation in which the logic circuitry is part of sensors 21.

In some examples, the logic circuitry of sensors 21 may alter the push rate based on thresholding determinations with respect to the air quality of environment 8A. In one example, the logic circuitry of sensors 21 may set a number of (e.g., five) categories of air quality based on levels PM concentration, and may change the data push rate in response to detecting a transition of the air quality into a new category. In another example, the logic circuitry of sensors 21 may change the data push rate in response to determining that the air quality has remained below a certain level for a predetermined threshold length of time. In another example still, the logic circuitry of sensors 21 may change the data push rate in response to determining that the air quality of environment 8A has diminished at or faster than a threshold rate. In another example, the logic circuitry may respond to a signal from the AQMS via network 4 to change the push rate based on data analysis that indicates a transition of the air quality at environment 8A into a different category. Various combinations that incorporate portions of the examples of the data listed above are also in accordance with aspects of this disclosure.

AQMS 6 is configured to use the air quality data obtained from environments 8 to provide air quality-related information to remote users 24 via computing devices 18. That is, remote users 24 may use computing devices 18 to interact with AQMS 6 via the communication capabilities provided by network 4. In some examples, AQMS 6 feeds air quality statistics and/or analysis thereof with respect to environments 8 to remote users 24 via computing devices 18. For instance, environment 8A represents a residence, and one or more of remote users 24 represent occupants of the residence. By leveraging the air quality information obtained from sensors 21 over network 4, AQMS 6 may generate alerts and communicate the alerts to remote users 24 via computing devices 18.

As such, AQMS 6 provides remote (and in some cases, wireless) indoor air quality monitoring and can help remote users 24 understand the indoor air quality at environment 8A is at a given time, and to receive alerts or recommendations on possible remediation measures. Using the heuristic data formed from alerts generated by AQMS 6 based on the indoor air quality at environment 8A, remote users 24 can identify particular activities that alter or change the indoor air quality at environment 8A. By communicating alerts and/or recommended remediation measures, AQMS 6 is configured to inform remote users 24 of any certain declines in the indoor air quality at environment 8A, and may thereby educate remote users 24 on activities to avoid, or remedial actions to take to improve the indoor air quality at environment 8A.

In one example, AQMS 6 may provide an alert to remote users 24 of a threshold drop in the indoor air quality at environment 8A, and may provide a recommendation to turn on the fan of HVAC system 16. By activating the fan of HVAC system 16 (e.g., by setting HVAC system 16 in a “fan only” mode), remote users 24 may avail themselves of additional air filtration provided by the air filter of HVAC system 16. In another example, AQMS 6 may automatically initiate one or more remedial measures at environment 8A. For instance, AQMS 6 may automatically initiate communications, via network 4, to the smart thermostat of HVAC system 6, to place HVAC system 6 in “fan only” mode.

AQMS 6 thereby leverages the enhanced PM sensing capabilities of sensors 21 to either initiate or to prompt remediation measures, or at the very least, to inform remote users 24 of the indoor air quality at environment 8A before remote users 24 return home. AQMS may provide the alert to remote users 24 in a variety of ways, such as via an app that pushes notifications to a mobile device (e.g., smartphone or tablet), or via a browser-accessible interface, as provided by a uniform resource locator (URL). In this way, AQMS 6 uses the systems of this disclosure to take advantage of the increasing deployment of mobile devices and the wider access to network resources to inform remote users 24 of air quality conditions at environment 8A and/or to initiate or prompt remediation measures to improve the same.

Moreover, the enhanced designs of sensors 21 as described in this disclosure enable AQMS 6 to monitor and provide alerts and/or remediation based on PM detection of an improved precision level. Currently-available PM sensor technology typically detects particles having sizes that vary from a ceiling of 2.5 micrometers (or “microns”) down to a floor of 0.5 microns. Using the enhanced designs of sensors 21, AQMS 6 provides detection and quantifying formation for so-called “ultrafine” particles, which are smaller than 0.5 microns in size. Ultrafine particles pose the greatest danger to health, because of their embeddability in the lungs and respiratory tracts, and also because of their potential absorbability into the bloodstream.

In some examples, AQMS 6 uses sensors 21 to detect PM that has a particle size as small as 0.075 microns, and provides alerts or remediation based on detection of these ultrafine particles. As described above, sensors 21 may detect scattering at multiple angles, thereby availing of the phenomenon of differently-sized small particles scattering at different angles. By using the deployment of multiple detection points (e.g., in the form of sensors 21), AQMS 6 may determine particle sizes detected in the air of environment 8A, such as by obtaining the ratios of detector angles to obtain the size distribution.

In some implementations, sensors 21 may be positioned within or coupled to one or more purifiers deployed at environment 8A. Examples of such air purifiers include an air purification component of HVAC system 16 and/or room air purifiers placed in environment 8A. Sensors 21 can be positioned within or coupled to other smart assistant devices deployed at environment 8A, as well. In various examples, AQMS 6 may provide recommended remediation measures that are associated with the air purifiers, such as a recommendation to activate or turn on one or more of the room air purifiers, to activate or intensify the settings of a central purifier, etc. In some examples, AQMS 6 may leverage smart home technology or other network connectivity facilities to automatically turn on the air purifier(s) or to adjust the settings of the air purifier(s) at environment 8A. An example of an air purifier consistent with the systems of this disclosure is a high efficiency particulate air (HEPA) filter.

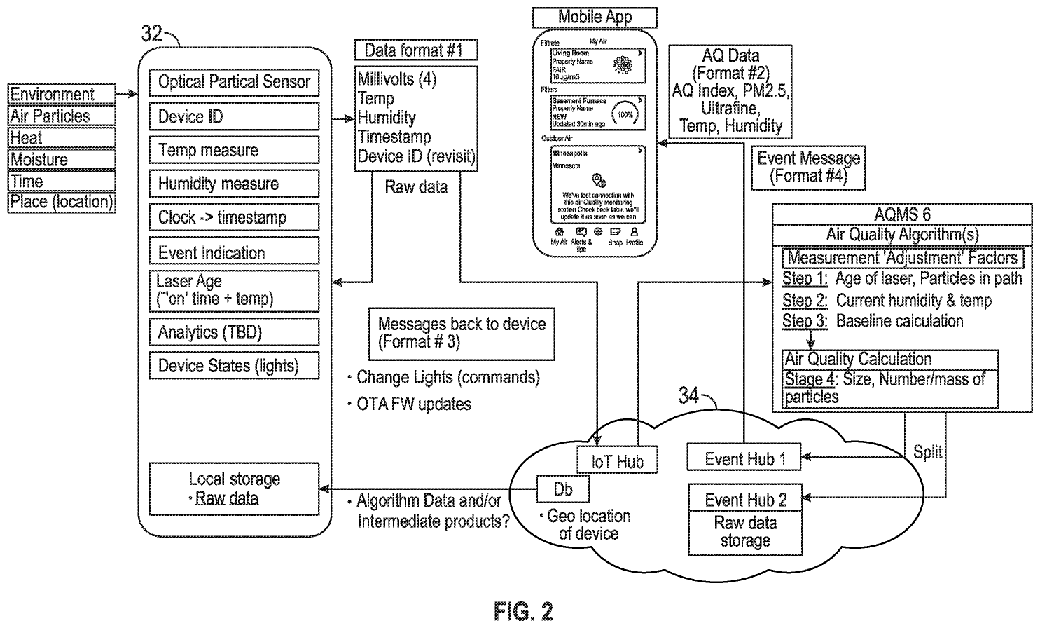

FIG. 2 is a conceptual diagram illustrating a data flow according to which AQMS 6 processes information about the air quality of environment 8A and provide monitoring and alert information to remote users 24. Home monitoring system (HMS) 32 acquires air quality data from sensors 21. The example of FIG. 2 is described herein with respect to (HMS) 32 obtaining air quality data from two sensors, namely, sensors 21A and 21B of FIG. 1, although it will be appreciated that the systems of this disclosure are compatible with varying numbers of sensors being deployed at environment 8A.

HMS 32 is configured to acquire four amplifier gain measurements from sensors 21, in the example implementation discussed herein. That is, in this example implementation, HMS 32 obtains two different amplifier gain measurements from sensor 21A, and two different amplifier gain measurements from sensor 21B. HMS 32 pushes data according to one or more formats, a non-limiting example of which is the message format illustrated in FIG. 2. As shown in the example message format of FIG. 2, HMS 32 may push the amplifier gain measurements as quantities expressed in units of millivolts (mV). The message format of FIG. 2 also includes data points describing other ambient characteristics at environment 8A, including temperature, humidity, the time at which the data points are gathered, etc.

HMS 32 may push the data at a predetermined “base” rate. In one example, the base rate is one push at one-minute intervals. However, HMS 32 may alter the push rate to deviate from the base rate, in response to one or more stimuli. In one example, HMS 32 changes the push rate to deviate from the base rate based on a determination that the air quality at environment 8A has crossed a threshold into a particular category of air quality. In another example, HMS 32 changes the push rate to deviate from the base rate based on a rate at which the PM contamination in the air at environment 8A has increased (e.g., as expressed by a second derivative value to illustrate a precipitous deterioration in air quality). In another example still, HMS 32 changes the push rate to deviate from the base rate based on a determination that the air quality at environment 8A has crossed into a threshold (into a particular category of air quality) a threshold number of times (e.g., based on a “recurrence” measure). In another example, HMS 32 changes the push rate to deviate from the base rate based on a determination that the air quality at environment 8A has crossed into a threshold (into a particular category of air quality) and stayed in the particular category, uninterrupted, for a predetermined length of time (e.g., based on a “persistence” measure).

HMS 32 may customize the criteria for push rate changes based on individual preferences or health conditions associated with remote users 24. In various examples, HMS 32 may implement the individual condition-based adjustment as an addition to one or more of the air quality-based adjustments described above. In other examples, HMS 32 may implement the individual condition-based adjustment as an alternative to the air quality-based adjustment techniques described above. One example of an individual condition-based adjustment criterion is documentation that one of the occupants of environment 8A suffers from asthma. If one of remote users 24 enters data (e.g., via the illustrated mobile app, or via the thermostat of HVAC system 16, etc.) indicating an asthmatic resident of environment 8A, HMS 32 may automatically adjust the push rate for all air quality deteriorations, or for contamination by certain specific PM types that are associated with aggravating asthma symptoms. Other individual conditions for which HMS 32 may adjust the push rate include chronic obstructive pulmonary disease (COPD), various forms of bronchitis, emphysema, cystic fibrosis, pneumonia, lung cancer, sleep apnea, and other chronic respiratory conditions, as well as other chronic conditions such as irregular heartbeat, etc.

HMS 32 is configured to push the data describing the air quality of environment 8A to edge device 34. Edge device 34, in some examples, represents an internet of things (IoT) data processing device, computing component, processor, or system. Edge device 34 implements cloud computing technology to process raw data received from HMS 32 and then generate air quality “event” information. In some examples, edge device 34 represents one or more devices that have sufficient computing power to quickly calculate AQ metrics, detect events, etc. without relying on cloud-based functionalities.

Edge device 34 identifies events based on various criteria, based on analysis of the raw data (including heuristic data) received HMS 32. In one example, edge device 34 defines or identifies an air quality event based on a determination that the air quality at environment 8A has crossed a threshold into a particular category of air quality. In another example, edge device 34 identifies or defines an air quality event based on a rate at which the PM contamination in the air at environment 8A has increased (e.g., as expressed by a second derivative value to illustrate a precipitous deterioration in air quality). In another example still, edge device 34 identifies an air quality event based on a determination that the air quality at environment 8A has crossed into a threshold (into a particular category of air quality) a threshold number of times (e.g., based on a “recurrence” measure). In another example, edge device 34 identifies an air quality event based on a determination that the air quality at environment 8A has crossed into a threshold into a particular category of air quality and stayed in the particular category, uninterrupted, for a predetermined length of time (e.g., based on a “persistence” measure).

Edge device 34 may customize the criteria for air quality event identification based on individual preferences or health conditions associated with remote users 24. In various examples, edge device 34 may implement the individual condition-based adjustment as an addition to one or more of the air quality-based event detections described above. In other examples, edge device 34 may implement the individual condition-based adjustment as an alternative to the air quality-based event detection techniques described above. Examples of individual condition-based event detection criteria is documentation that one of the occupants of environment 8A suffers from asthma. If one of remote users 24 enters data (e.g., via the illustrated mobile app, or via the thermostat of HVAC system 16, etc.) indicating that a resident suffers from one or more conditions, such as asthma, COPD, various forms of bronchitis, emphysema, cystic fibrosis, pneumonia, lung cancer, sleep apnea, and other chronic respiratory conditions, as well as other chronic conditions such as irregular heartbeat, etc.

While edge device 34 is illustrated separately from AQMS 6 in the example of FIG. 2, it will be appreciated that, in some implementations, portions or all of the functionalities described with edge device 34 and AQMS 6 may be integrated. In the implementation illustrated in FIG. 2, edge device 34 is configured to provide event detection information to AQMS 6. In some examples, edge device 34 and/or AQMS 6 may leverage cloud-to-cloud interactions (e.g., smart home cloud technologies such as those provided by Nest® Labs, etc.) to generate or modify event detection parameters. Examples of cross-cloud data usage are described with respect to FIG. 2 as functionality attributed to AQMS 6, although it will be appreciated that other components illustrated in FIG. 2, such as edge device 34, may implement cross-cloud data acquisition in accordance with aspects of this disclosure, as well.

Examples of data that AQMS 6 may leverage from cross-cloud acquisition include smoke detection information, toxic gas (e.g., carbon monoxide detection), heat sensing information, flooding detection, gas leak detection, and others. Using the information obtained via cross-cloud technology, AQMS 6 may tune the event detection information to mitigate or potentially eliminate false positives, to provide a more complete context of the health hazards posed by the air quality, etc. For instance, AQMS 6 may prune the list of detected events to eliminate false positive event detection caused by kitchen activity (e.g., frying food) or other conditions that change the composition of the air at environment 8A without posing health hazards. To eliminate false positives, AQMS 6 may leverage knowledge of which elements in the air are harmful and which are not. By detecting these elements and classifying them as such, or by drawing an inference based on other activity collected, AQMS 6 may tune the data to eliminate false positives. For example, AQMS 6 may leverage data that the end users are cooking at environment 8A, and that the measurable PM associated with the smell of cooking food is not harmful. However, if the food being cooked starts to burn and generates smoke, then AQMS 6 may determine that the PM has become harmful or undesirable. These other inputs (e.g., data that someone is cooking but is not burning the food) can be used in accordance with the systems of this disclosure to inform the AQ event identification decisions, and to tune the outputs accordingly. Whether AQMS 6 is configured to operate in a standalone fashion or in tandem with other smart home cloud technologies, it will be understood that HMS 32, edge device 34, and AQMS 6, whether individually or in any combination thereof, do not function as a substitute for smoke detection, carbon monoxide detection, or other safety functionalities with which homes are commonly equipped.

After tuning and/or supplementing the event information with additional data, AQMS 6 may communicate the nature of the event to edge device 34, to then be relayed to computing devices 18. One example of computing devices 18 is the mobile device (e.g., a smartphone) illustrated in FIG. 2. The mobile app interface illustrated in FIG. 2 provides one or more of remote users 24 with air quality information and other air-related conditions at environment 8A. In the example of FIG. 2, the mobile app interface provides data indicating that the air quality at environment 8A is “fair” from the standpoint of PM levels, and that the furnace (or the air filter thereof) of HVAC system 16 is in good condition. The mobile app interface also provides comparative information with respect to the outdoor air quality, depending on data availability and network/server connectivity. The “fair” rating of the indoor air quality in a living room area of environment 8A is based on a PM measurement of 16 micrograms per cubic meter of air sampled.

In various examples AQMS 6 and/or edge device 34 may push notifications to the mobile device of computing devices 16, via the mobile app, to provide air quality (AQ) event alerts. That is, even if the mobile app is not the currently-viewed interface, the mobile device of computing devices 16 may output visual and/or auditory notifications to alert the pertinent remote user 24 of the AQ event at environment 8A. In some examples, AQMS 6 may supplement the alerts with recommended remediation measures, such as a recommendation to activate or turn on one or more room air purifiers deployed at environment 8A, to activate or intensify the settings of a central air purifier of environment 8A, etc. In this way, the systems of this disclosure leverage the relative ubiquity of mobile computing devices to provide alerts and/or recommended remediation actions to remote users.

Examples of recommended remediation measures that AQMS 6 and/or edge device 34 may push to computing devices 16 include recommendations to replace the air filter of HVAC system 16, to activate humidification or dehumidification functionalities of HVAC system 16, to change the settings (e.g., a filtration granularity level, such as installing a higher-performance filter) of HVAC system 16, etc. In some examples, AQMS 6 and/or edge device 34 may also provide computing devices 16 with area-to-area comparisons of air quality within environment 8A to be displayed via the mobile app interface. In this way, AQMS 6 and/or edge device 34 may help remote users 24 pinpoint one or more causes of the current air quality. In some examples, AQMS 6 is configured to automatically implement one or more remediation measures, thereby remediating the air quality problems without time delays that remote users 24 could potentially cause. While illustrated in FIG. 2 by way of a mobile app interface, the systems of this disclosure may provide air quality information in formats that can be displayed by other means, such as via a browser interface, via SMS or MMS, via voice call (voice telephony-based), etc.

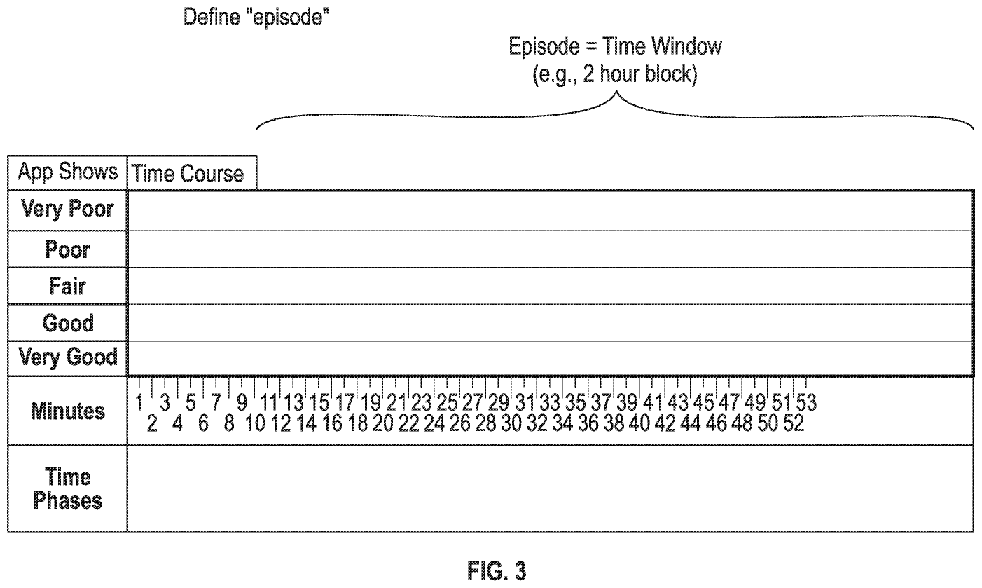

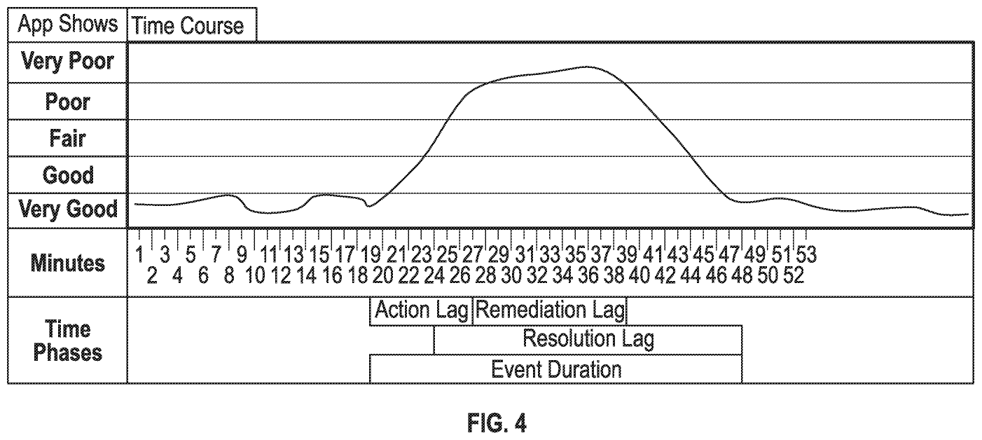

FIG. 3 is a graph illustrating a time window that AQMS 6 may use to define an air quality “episode.” For instance, AQMS 6 may use the time window defining an episode as a sample size within which to monitor air quality at environments 8 and use the data to describe the full span of an AQ event. In the example of FIG. 4, AQMS 6 uses a two-hour time window to define an air quality episode, and AQMS 6 may use other time windows as well, in accordance with the techniques of this disclosure.

FIG. 4 is a graph illustrating an example of air quality categorization that AQMS 6 may implement, in accordance with aspects of this disclosure. In the example of FIG. 3, AQMS 6 uses a five-level structure to categorize the air quality at any of environments 8. The five levels illustrated in FIG. 3 are termed, in decreasing order of favorability, as “very good,” “good,” “fair,” “poor,” and “very poor.” It will be appreciated that various categorization structures are compatible with the techniques described herein, and that the structure shown in FIG. 4 is only one non-limiting example.

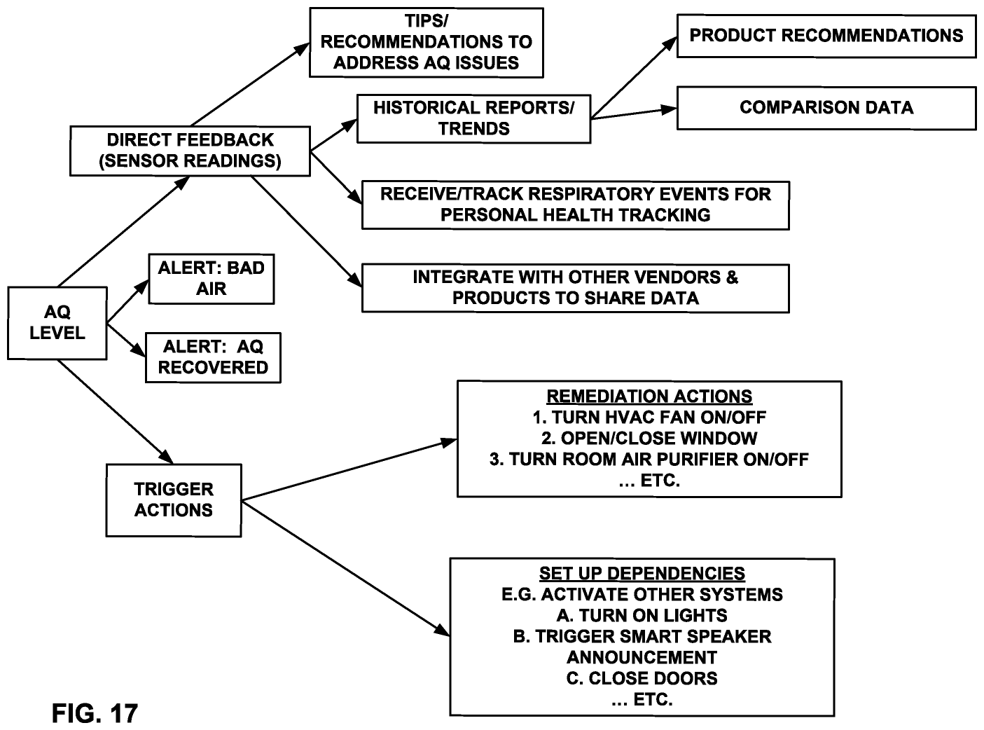

In the example of FIG. 4, AQMS 6 and/or edge device 34 may push notifications in response to the air quality at any of environments 8 deteriorating into one of the fair, poor, or very poor categories. The time phases described at the bottom of FIG. 4 ‘lag’ times that represent different phases of an event, potentially for the purposes of diagnosis and future remediation. That is, AQMS 6 and/or edge device 34 may tag components of an AQ event for analysis by various means that lead to various types of behavior or system change. One example is how to reduce the ‘action lag’ between measuring poor AQ and AQMS 6/edge device 34/individual users starting to address the source of the problem. As another example, the systems of this disclosure may incorporate a smart system that can filter out the smoke from the air via activating an HVAC or an air purifier (e.g., a central purification system or one or more room air purifiers), or opening a window (or recommending that a user open a window), and/or identifying a way to put out the fire (e.g., turn off a smart or connected stove, which may be the source of the smoke, etc.). More generally, FIG. 4 identifies the components of air quality ‘events’ for potential additional uses and features of one example overall system of this disclosure. There may also be a number of potential user inputs that the app (illustrated in FIG. 2) may collect about AQ events according to configurations of this disclosure, such as user-provided labels/tags for AQ events, actions the users took, the sources of contamination, etc. Leveraging a broader variety of data in this way may provide a richer (e.g., more data-rich and comprehensive) system for managing air quality. The various definitions of ‘events’ discussed herein may encompass these data or other types of data gathered via the app or gathered in other ways. One such example is illustrated in FIG. 17 and discussed in further detail below with respect to FIG. 17 (e.g., “receive/track respiratory events for personal health tracking”), which represents one example of a purpose for capturing meta data about AQ events. Other purposes for capturing metadata about the AQ events may include diagnosis and causal analysis, whether for health reasons or prevention of other effects of PM, such as impact on machines or other systems that may not immediately impact living organisms.

The notifications for deteriorating air quality are termed an “escalation sequence.” Conversely, AQMS 6 and/or edge device 34 may push notifications to computing devices 18 according to a “de-escalation sequence” as well. That is, if the air quality at any of environments 8 improves into any of the poor, fair, good, or very good categories, AQMS 6 and/or edge device 34 may push notifications for these transitions as well. Based on the air quality remaining in the very good category for a threshold length of time after an AQ event, AQMS 6 and/or edge device 34 may push a notification to computing devices 18 to indicate that the AQ event is resolved or otherwise over.

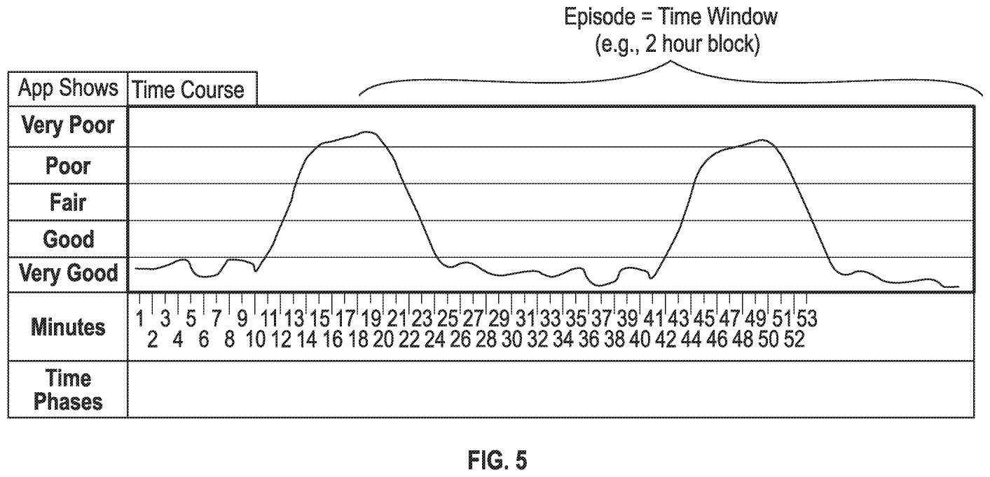

FIG. 5 is a graph illustrating an air quality event that is detected based on recurrence. In this example, AQMS 6 identifies an AQ event at one of environments 8, based on the repeated occurrence of the indoor air quality deteriorating (i.e., moving in the direction of the escalation sequence) into the very poor category. In the specific example of FIG. 5, AQMS 6 identifies the AQ event based on a two-time recurrence of a deterioration into the very poor category. However, it will be appreciated that AQMS 6 may use different criteria to detect a recurrence-based AQ event at one or more of environments 8. For instance, AQMS 6 may increase the threshold number of recurrences over two, and/or may decrease the severity of indoor air quality deterioration, such as transitions into the poor category in the direction of the escalation sequence.

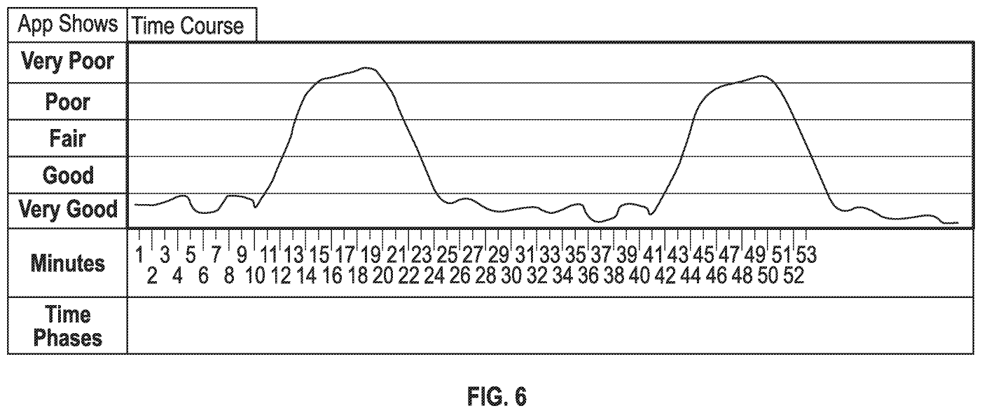

FIG. 6 is a graph illustrating an air quality event that is detected based on recurrence, but with a different time window from FIG. 5. For instance, the time window in the case of FIG. 6 may be open-ended.

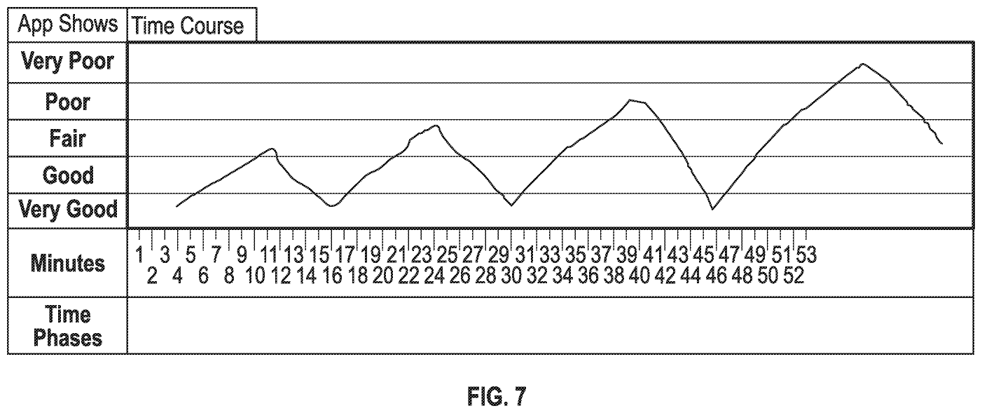

FIG. 7 is a graph illustrating another air quality event that is detected based on recurrence. In this example, AQMS 6 identifies an AQ event at one of environments 8, based on the repeated occurrence of the indoor air quality deteriorating (i.e., moving in the direction of the escalation sequence) into a less desirable category, with the severity of the air quality deterioration becoming more acute at each subsequent recurrence. That is, in the example of FIG. 7, AQMS 6 adds a second criterion to the recurrence detection. As shown by the peaks of the graph in FIG. 6, AQMS 6 detects a four-time recurrence, with each peak being positioned in a more severe air quality degradation category than the immediately prior peak. As such, FIG. 7 illustrates an example in which AQMS 6 detects an AQ event based on recurrence and increased acuity with the recurrence.

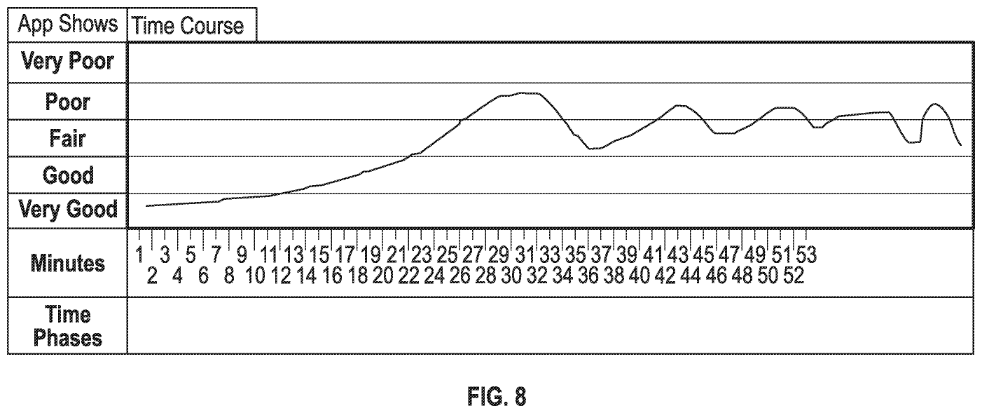

FIG. 8 is a graph illustrating another air quality event that is detected based on air quality fluctuation. In this example, AQMS 6 identifies an AQ event at one of environments 8, based on the number and magnitude of air quality swings within the predefined time window (e.g., two hours). As such, FIG. 8 illustrates an example in which AQMS 6 detects an AQ event based on instability issues with respect to the indoor air quality at one of environments 8.

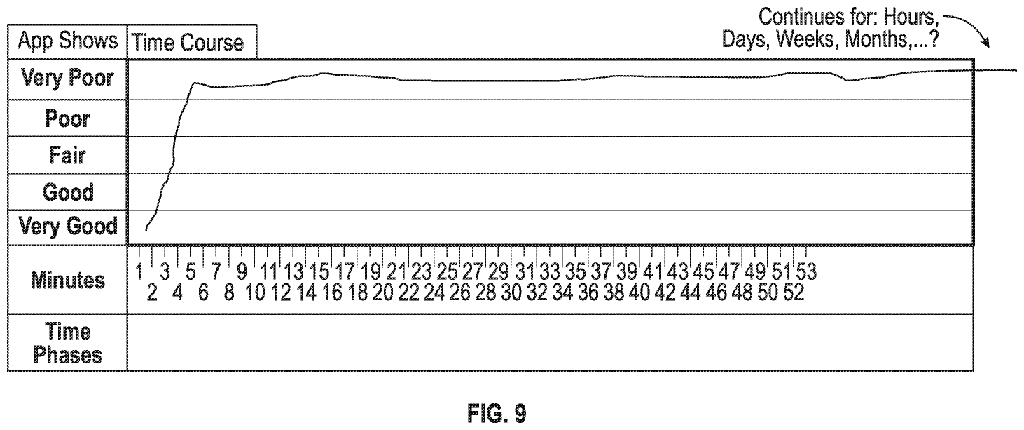

FIG. 9 is a graph illustrating another air quality event that is detected based on persistence. In this example, AQMS 6 identifies an AQ event at one of environments 8, based on the indoor air quality deteriorating (i.e., moving in the direction of the escalation sequence) into a less desirable category, and remaining in the less desirable category for at least a predetermined threshold length of time, at a stretch. That is, in the example of FIG. 9, AQMS 6 adds a second criterion to AQ event detection that is based on a simple transition (e.g., as shown by a first derivative of the air quality metrics). As shown by the peak and subsequent plateau of the graph in FIG. 8, AQMS 6 detects a simple transition of the indoor air quality into the very poor category, with the air quality remaining in the very poor category for a threshold period of time at a stretch. In other examples, AQMS 6 may implement persistence-based AQ event detection using different criteria, such as a deterioration into the poor category, with the air quality remaining in either the poor or very poor category for a threshold length of time.

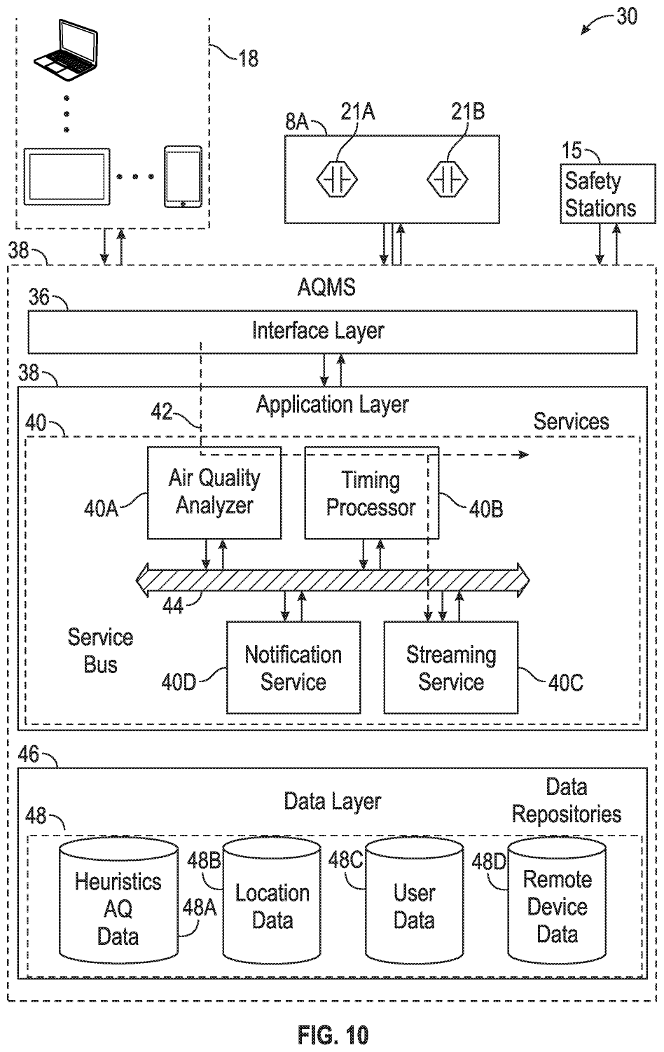

FIG. 10 is a block diagram providing an operating perspective of AQMS 6 when hosted as a cloud-based platform capable of supporting multiple, distinct work environments 8 equipped with sensors 21, in accordance with various techniques of this disclosure. In the example of FIG. 10, the components of AQMS 6 are arranged according to multiple logical layers that implement the techniques of the disclosure. Each layer may be implemented by one or more modules and may include hardware, a combination of hardware and software, or software implemented by hardware. Various functionalities described with respect to components of AQMS 6 may be implemented by processor technology, such as microprocessors, digital signal processors (DSPs), application specific integrated circuits (ASICs), field programmable gate arrays (FPGAs), or equivalent discrete logic circuitry or integrated logic circuitry, processing circuitry (e.g., fixed function circuitry and/or programmable processing circuitry), or a combination of any of the foregoing devices or circuitry.

While shown in FIG. 10 as being a single device, it will be appreciated that the functionalities described herein with respect to AQMS 6 may be distributed across multiple devices and/or systems in accordance with this disclosure, such as between AQMS 6 and edge device 34, or in other ways. Computing devices 18 typically execute client software applications, such as desktop applications, mobile applications, and/or web applications. Examples of computing devices 18 may include, but are not limited to, a portable or mobile computing device (e.g., smartphone, wearable computing device, tablet), laptop computers, desktop computers, smart television platforms, and/or servers.

In some examples, computing devices 18 communicate with AQMS 6 to send and receive information related to the indoor air quality of environment 8A, and optionally, potential hazards and/or AQ events, remediation measures with respect to the indoor air quality at environment 8A, etc. For instance, client applications executing on computing devices 18 may communicate with AQMS 6 to send and receive information that is retrieved, stored, generated, and/or otherwise processed by services 40. For example, as described above, AQMS 6 may provide, to the client applications running on computing devices 16, air quality monitoring information obtained from sensors 21, potential hazards or AQ events, recommended remediation measures, reports of automatically-implemented remediation measures, etc. In some examples, client applications may request and display information generated by AQMS 6, such as an AVR display including one or more indicator images. In addition, the client applications may interact with AQMS 6 to query for analytics information about PPE compliance, safety event information, audit information, or the like. The client applications may output for display information received from AQMS 6 to visualize such information for users of clients 30. As further illustrated and described below, AQMS 6 may provide information to the client applications, which the client applications output for display in user interfaces.

Client applications executing on computing devices 18 may be implemented for different platforms but include similar or the same functionality. For instance, a client application may be a desktop application compiled to run on a desktop operating system, such as Microsoft® Windows®, Apple® OS X®, or Linux®, etc. to name only a few examples. As another example, a client application may be a mobile application compiled to run on a mobile operating system, such as Google® Android®, Apple® iOS®, Microsoft® Windows Mobile®, or BlackBerry® OS, etc. to name only a few examples. As another example, a client application may be a web application such as a web browser that displays web pages received from AQMS 6. In the example of a web application, AQMS 6 may receive requests from the web application (e.g., the web browser), process the requests, and send one or more responses back to the web application. In this way, the collection of web pages, the client-side processing web application, and the server-side processing performed by AQMS 6 collectively provides the functionality to perform techniques of this disclosure. In this way, client applications use various services of AQMS 6 in accordance with techniques of this disclosure, and the applications may operate within different computing environments (e.g., a desktop operating system, mobile operating system, web browser, or other processors or processing circuitry, to name only a few examples).

As shown in FIG. 10, in some examples, AQMS 6 includes an interface layer 36 that represents a set of application programming interfaces (API) or protocol interface presented and supported by AQMS 6. Interface layer 36 initially receives messages from any of computing devices 18 for further processing at AQMS 6. Interface layer 36 may therefore provide one or more interfaces that are available to client applications executing on computing devices 18. In some examples, the interfaces may be application programming interfaces (APIs) that are accessible over network 4. In some example approaches, interface layer 36 may be implemented with one or more web servers. The one or more web servers may receive incoming requests, may process, and/or may forward information from the requests to services 40, and may provide one or more responses, based on information received from services 40, to the client application that initially sent the request. In some examples, the one or more web servers that implement interface layer 36 may include a runtime environment to deploy program logic that provides the one or more interfaces. Interface layer 36 may support communications according to various communication protocols, including, but not limited to, the Message Queuing Telemetry Transport (MQTT) protocol, which is described in ISO/IEC PRF 20922 and works on top of the TCP/IP protocol. As further described below, each service may provide a group of one or more interfaces that are accessible via interface layer 36.

In some examples, interface layer 36 may provide Representational State Transfer (RESTful) interfaces that use HTTP methods to interact with services and manipulate resources of AQMS 6. In such examples, services 40 may generate JavaScript Object Notation (JSON) messages that interface layer 36 sends back to the client application that submitted the initial request. In some examples, interface layer 36 provides web services using Simple Object Access Protocol (SOAP) to process requests from client applications. In still other examples, interface layer 36 may use Remote Procedure Calls (RPC) to process requests from clients 30. Upon receiving a request from a client application to use one or more services 40, interface layer 36 sends the information to application layer 38, which includes services 40.

As shown in FIG. 10, AQMS 6 also includes an application layer 38 that represents a collection of services for implementing much of the underlying operations of AQMS 6. Application layer 38 receives information included in requests received from client applications that are forwarded by interface layer 36 and processes the information received according to one or more of services 40 invoked by the requests. Application layer 38 may be implemented as one or more discrete software services executing on one or more application servers, e.g., physical or virtual machines. That is, the application servers provide runtime environments for execution of services 40. In some examples, the functionality of interface layer 36 as described above and the functionality of application layer 38 may be implemented at the same server.

Application layer 38 may include one or more separate software services 40 (e.g., processes) that may communicate via, for example, a logical service bus 44. Service bus 44 generally represents a logical interconnection or set of interfaces that allows different services to send messages to other services, such as by a publish/subscription communication model. For example, each of services 40 may subscribe to specific types of messages based on criteria set for the respective service. When a service publishes a message of a particular type on service bus 44, other services that subscribe to messages of that type will receive the message. In this way, each of services 40 may communicate information to one another. As another example, services 40 may communicate in point-to-point fashion using sockets or other communication mechanism. Before describing the functionality of each of services 40, the layers are briefly described herein.

Data layer 46 of AQMS 6 represents a data repository 48 that provides persistence for information in AQMS 6 using one or more data repositories 48. A data repository, generally, may be any data structure or software that stores and/or manages data. Examples of data repositories include but are not limited to relational databases, multi-dimensional databases, maps, and/or hash tables. Data layer 46 may be implemented using Relational Database Management System (RDBMS) software to manage information in data repositories 48. The RDBMS software may manage one or more data repositories 48, which may be accessed using Structured Query Language (SQL). Information in the one or more databases may be stored, retrieved, and modified using the RDBMS software. In some examples, data layer 46 may be implemented using an Object Database Management System (ODBMS), Online Analytical Processing (OLAP) database, or any other suitable data management system.

As shown in FIG. 10, each of services 40A-40D (collectively, “services 40”) is implemented in a modular form within AQMS 6. Although shown as separate units for each service, in some examples the functionality of two or more services may be combined into a single unit or component. Each of services 40 may be implemented in hardware, hardware that implements software, or a combination of hardware and software. Moreover, services 40 may be implemented as standalone devices, separate virtual machines or containers, processes, threads, or software instructions generally for execution on one or more physical processors or processing circuitry.

In some examples, one or more of services 40 may each provide one or more interfaces 42 that are exposed through interface layer 36. Accordingly, client applications of computing devices 18 may call one or more interfaces 42 of one or more of services 40 to perform techniques of this disclosure. In the example of FIG. 10, services 40 include an air quality analyzer 40A. Air quality analyzer 40A is configured to process air quality metrics obtained from sensors 21 about the indoor air quality of environment 8A. Air quality analyzer 40A may receive raw data describing the indoor air quality at environment 8A, and may process the data, either in isolation or in a synergistic sense with other air-related conditions at environment 8A, to draw inferences about the indoor air quality at environment 8A. In some examples, heuristics data repository 48A may store past indoor air quality metrics and/or air quality inferences about environments 8. In some examples, air quality analyzer 40A may leverage this information available from heuristics data repository 48A to tune inferences drawn about the current indoor air quality at environments 8.

Application layer 48 of AQMS 6 also includes timing processor 40B. Timing processor 40B is configured to set or adjust various time-related parameters that air quality analyzer 40A may use for determining air quality characteristics at environments 8, using the raw data received from sensors 21. As one example, timing processor 40B may set or adjust the time window (as shown in FIG. 4) that air quality analyzer 40A uses to analyze a single AQ episode at environments 8. As another example timing processor 40B may set or adjust the threshold period of time that air quality analyzer 40A uses as a criterion for persistence-based AQ event detection (as illustrated in FIG. 8).

Application layer 38 of AQMS 6 also includes streaming service 40C. Streaming service 40C is configured to provide timed updates on the air quality at environment 8A to computing devices 18 via interface layer 36. Streaming service 40C may cease the streaming to any of computing devices 18 if that particular computing device 18 deactivates streaming services. Streaming service 40C may identify devices that for which streaming services are activated and devices for which streaming services are deactivated using remote device data repository 48D. For instance, remote device data repository 48D may store MAC addresses, static IP addresses, or any other device-identifying information that streaming service 40C can use to identify any of computing devices 18 individually.

Application layer 38 of AQMS 6 also includes notification service 40D. Notification service 40D is configured to push notifications to one or more of computing devices 18, in response to air quality analyzer 40A detecting an AQ event at environment 8A. In some examples, notification service 40D tunes the notifications based on individual preferences or health conditions associated with remote users 24. For instance, notification service 40D may determine individual preferences or health conditions of remote users 24 by accessing data available from user data repository 48C. Based on user preferences and/or health conditions obtained from user data repository 48C, notification service 40D may push notifications more aggressively for certain types of PM or certain AQ events, or may push notifications less aggressively (sometimes eliminating the notifications altogether) for certain types of PM or certain AQ events. Examples of health conditions that remote users 24 may populate into user data repository 48C are discussed above.

Various services 40 may also use location data repository 48B to inform certain determinations or actions. Location data repository 48B may store, at various time intervals, the location of remote devices 18. For instance, location data repository 48B may store GPS coordinates, logical IP addresses, VPN tunnel information, etc. from which AQMS 6 can extrapolate the physical location of one or more of computing devices 18. Using the data available from location data repository 48B, notification service 40D, for example, may increase or decrease the aggressiveness or the communication type of notifications based on the physical proximity of the respective computing device 18 to environment 8A. As one example, if notification service 40D determines that the remote user 24 of a smartphone of computing devices 18 is within close proximity of environment 8A, notification service 40D may escalate the notification medium from push notifications to voice calls, in an effort to more expeditiously inform the respective remote user 24 of an AQ event (e.g., posing a potential health hazard) at environment 8A before the respective remote user 24 arrives at environment 8A.

FIG. 11 is a cross-sectional diagram depicting a particle detector 52, in accordance with some examples of this disclosure. In some examples, particle detector 52 may be configured to detect and indicate the presence of fine and ultrafine particulate matter in the air surrounding the detector. For example, particle detector 52 may be configured to detect the presence of microscopic particles suspended in air by passing a sample of air containing those particles through the body of the sensor, scattering a beam of light off the particles, and then sensing the scattered light with photosensitive sensors at one or more pre-determined scattering angles. In some examples, particle detector 52 may be configured to pass a sample of air through the detector, from an air intake 60 to an air exhaust 62, in a direction 80 that is oriented substantially away from the angle of optical light sensors 68A and 68B (collectively, sensors 68), such that particulate matter in the air sample will not reduce or foul the sensitivity of the sensors over time. In some examples, particle detector 52 may include a light trap 72 to redirect and/or capture un-scattered particles from the beam of light, significantly reducing noise in light sensors 68 and increasing the overall sensitivity and accuracy of the detector.

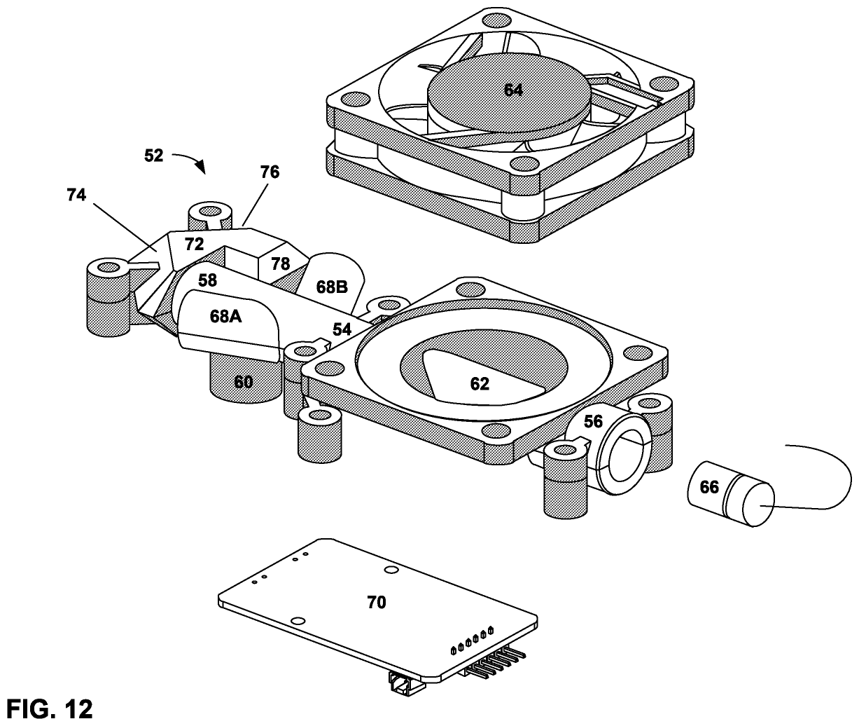

FIG. 12 is an exploded view depicting a particle detector 52, in accordance with some examples of this disclosure. Particle detector 52 is configured to detect and indicate the amounts and/or relative concentrations of fine and ultrafine particulate matter suspended in the air surrounding the detector.

In some examples, particle detection device 52 includes a housing 54, comprising the main body of the detector. In the example depicted in FIG. 12, housing 54 includes a substantially elongated tubular member or cylinder. Housing 54 may include two opposing ends or sides, for example, proximal end 56 and distal end 58. The shape of housing 54 may define a longitudinal axis through an internal cavity of detector 52, such as an axis drawn from proximal end 56 to distal end 58.

Housing 54 may also include or define air intake port 60 and air exhaust port 62. In some examples, air intake port 60 may include a hole or opening defined in the outer surface of housing 54. In other examples, such as the example depicted in FIG. 12, air intake port 60 may also include a channel extending outward from housing 54, i.e., extending radially from the longitudinal axis.

In some examples, air intake port 60 may be disposed near distal end 58 of housing 54, and air exhaust port 62 may be disposed near proximal end 56 of housing 54, such that a flow of air may substantially traverse the internal cavity of housing 54 from distal end 58 toward proximal end 56, i.e., in a direction substantially opposite, but parallel to, the longitudinal axis through housing 54.

In some examples, particle detector 52 may also include a fan 64 disposed over air exhaust port 62, near the proximal end 56 of housing 54. Fan 64 may be configured to draw air into housing 54 from air intake port 60, pulling the air from distal end 58 toward proximal end 56, and expelling the air from exhaust port 64, and outward between the blades of fan 64.

In another example, fan 64 may be disposed near the distal end 58 of housing 54, and configured to propel air toward an air exhaust port disposed near proximal end 56 of housing 54. In either of these examples, the air surrounding detection device 52 is ingressed into the housing 54 of the device near distal end 58, and egressed near proximal end 56.

Detector 52 may also include a source of electromagnetic light 66 disposed at or near proximal end 56 of housing 54. In the example depicted in FIG. 5, light source 66 includes a laser emitter. Light source 66 may be selected based on the desired wavelength or frequency of the light to be emitted, in that different frequencies of light may have different scattering properties. In some examples, light source 66 may include a controller to selectively vary the frequency of light emitted without replacing the entire light source 66.

Light source 66 may be configured to emit a beam of light through the internal cavity of detector 52, along the longitudinal axis from proximal end 56 toward distal end 58 of housing 54, such that the direction of the propagation of the beam of light is substantially opposite to the direction of the flow of air through housing 54.

The beam of light emitted by light source 66 may be configured to interact with the flow of air passing through housing 54. For example, waves of light emitted by light source 66 may collide with, and scatter off of, particulate matter suspended within the air flow.

Detector 52 may include one or more optical light sensors, such as sensors 68A and 68B (collectively, “sensors 68”). Sensors 68 may include a photosensitive material, configured to generate and output an electrical signal when struck by a particle or wave of electromagnetic light, in accordance with the photoelectric effect. Each of sensors 68 may be attached to the outer surface of housing 54, oriented at a particular angle relative to the direction of the initial propagation of the electromagnetic waves emitted by light source 66.

According to multiple theories of physics, including Mie Theory, Fraunhofer Diffraction, and Raleigh Scattering, the scattering angle of electromagnetic waves is known to be correlated to the size of the individual particles of particulate matter that scatters them. For example, Mie Theory describes systems in which the wavelength of light is a similar order of magnitude as the diameter of the particle that scatters it, such as when 500 nm-wavelength light is scattered off of a 0.5-micron-diameter particle. In these scenarios, the diameter of the scattering particle has been found to be approximately inversely proportional to the sine of the scattering angle. Accordingly, by orienting sensors 68 at a predetermined scattering angle relative to the beam of light emitted by light source 66, detector 52 may indicate the presence of particulate matter of a particular size.

In the example depicted in FIG. 5, optical sensor 68A is disposed at an angle of approximately 30° with respect to the longitudinal axis through housing 54, in order to detect light scattered at an angle of 30°. Additionally, optical sensor 68B is disposed at an angle of approximately 60° with respect to the longitudinal axis through housing 54, in order to detect light scattered at an angle of 60°. These examples are not intended to be limiting. Particle detector 52 may include any number of optical sensors 68, each sensor configured to detect light scattered at a different predetermined scattering angle. Additionally, each of sensors 68 may also include circuitry and a controller for varying its angle with respect to the longitudinal axis, such that a single optical sensor 68 may detect light scattered by a wide spectrum of particle sizes.

In accordance with some aspects of this disclosure, sensors 68 may be disposed at an angle of less than 90° from the longitudinal axis through housing 54. In this configuration, the direction of the flow of air through housing 54 is directed substantially away from sensors 68, drawing the particulate matter suspended within the air flow in a direction substantially away from the sensors. This configuration may generate a low-pressure region in front of each of sensors 68, reducing or preventing a build-up of particulate matter in front of optical sensors 68 that would otherwise “foul” the sensors by reducing their detection sensitivity over time.

In some examples, optical sensors 68 may be in communication with sensing circuit 70, such as via a direct electrical connection or a wireless connection, such as Wi-Fi, Bluetooth, etc. When scattered light strikes one of sensors 68, sensors 68 may generate a corresponding electrical signal and communicate it to sensing circuit 70 for data processing by a computing device including processing circuitry and/or a memory device. For example, sensing circuit 70 may determine, from raw electrical signals output by sensors 68, an amount and/or a relative concentration of one or more sizes of particulate matter in the air. Sensing circuit 70 may then output this information for further uses, such as storage in memory, generation of alerts, or further data processing. In some examples, each of sensors 68 may be configured to conduct two or more measurements of scattered light, such as a high-level and a low-level measurement, in order to increase the accuracy of particle detection and analysis.

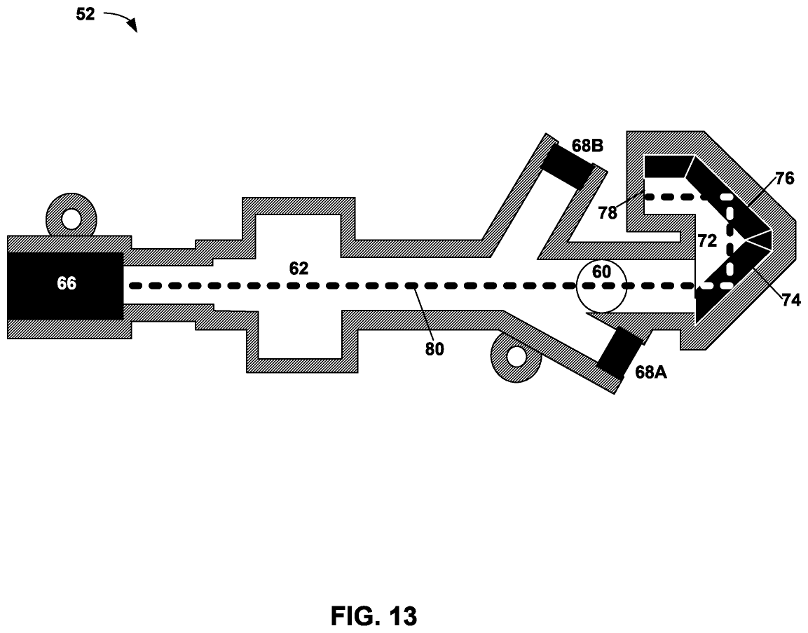

FIG. 13 is an overhead view depicting a particle detector 52, in accordance with some examples of this disclosure. In some examples, particle detector 52 may include a light source 66 that emits a beam of light 80 directed toward a stream of air, such that the light 80 may at least partially scatter off of particulate matter suspended in the air and into one or more of optical sensors 68.

In some examples in accordance with this disclosure, any residual light from the initial beam of light 80, i.e., light that was not scattered off of a particle of particulate matter, may propagate through a distal end of detector 52 and into light trap 72. Light trap 72 may include means for redirecting and/or absorbing any residual photons, preventing them from otherwise re-entering the internal cavity of detector 52 and further scattering into sensors 68. In some examples, light trap 72 may significantly increase the sensitivity and accuracy of particle detector 52 by reducing or preventing stray photons from triggering sensors 68 from angles not actually indicative of the known, pre-determined scattering angles from which a particle size may be determined.

In some examples, such as the example depicted in FIG. 13, light trap 72 may include at least one wall or planar facet 74. Planar facet 74 may, for example, be oriented at an angle of approximately 45° with respect to initial beam of light 80, such that the residual light may be reflected in a direction substantially perpendicular to the initial beam. In some examples, planar facet 74 may be composed of a substantially dark or black material, so as to absorb an amount of residual light that is not otherwise reflected off its surface. Additionally, the internal surface of planar facet 74 may include a substantially smooth finish, so as to increase the amount of residual light will be reflected approximately perpendicularly, as opposed to randomly scattering backward off of rough surface features. For example, the surface finish of planar facet 74 may have a rating of “A” by the Society of Plastics Industry (SPI-A), indicating a “very smooth” surface, as opposed to a rating of SPI-D, indicating a rougher surface finish.

In some examples, light trap 72 may further include a second planar facet 76. Second planar facet 76 may be oriented at an angle approximately of 90° to first planar facet 74, further directing stray photons away from the internal cavity detector 52 and optical sensors 68. Second planar facet 76 may also be composed of a substantially dark or black material, further absorbing stray photons that may otherwise interfere with sensors 68. After reflecting off of second planar facet 76, any few remaining photons may be travelling in a direction parallel to, but opposite to, initial beam of light 80.

Light trap 72 may further include a third planar facet 78. Third planar facet 78 may be oriented at an angle of approximately 45° to first planar facet 74 and to second planar facet 76, and perpendicular to both initial beam of light 80 and the photons reflected off of second planar facet 76. Third planar facet 78 may also be composed of a substantially dark or black material, so as to absorb any remaining photons, rather than reflect them back into detector 52.

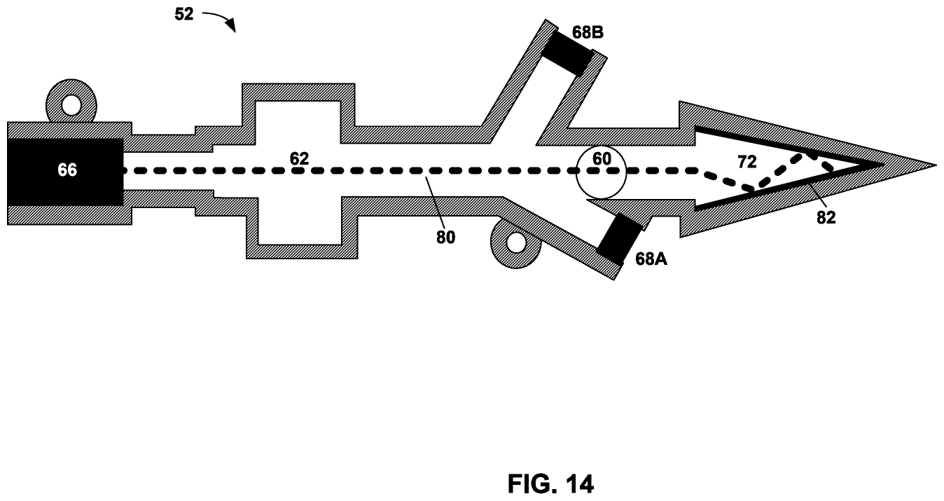

FIG. 14 is an overhead view depicting a particle detector 52, in accordance with some examples of this disclosure. In some examples, particle detector 52 includes light trap 72, configured to absorb and/or redirect any residual light that was not initially scattered by particulate matter into one of detectors 68.

In the example configuration depicted in FIG. 14, light trap 72 includes a substantially conical shape. In this configuration, residual photons from initial beam of light 80, emitted by light source 66, may strike the angular walls 82 of light trap 72. In some examples, walls 82 of light trap 72 may be composed of a substantially smooth and dark material, such that stray photons are either absorbed by the dark material, or reflected off the smooth surface in a direction further toward the tip of the cone and away from detector 52. In some examples, conical light trap 72 may include a substantially circular cross-section. In other examples, conical light trap 72 may include a cross-sectional area comprising any n-sided polygon, such as an octagon.

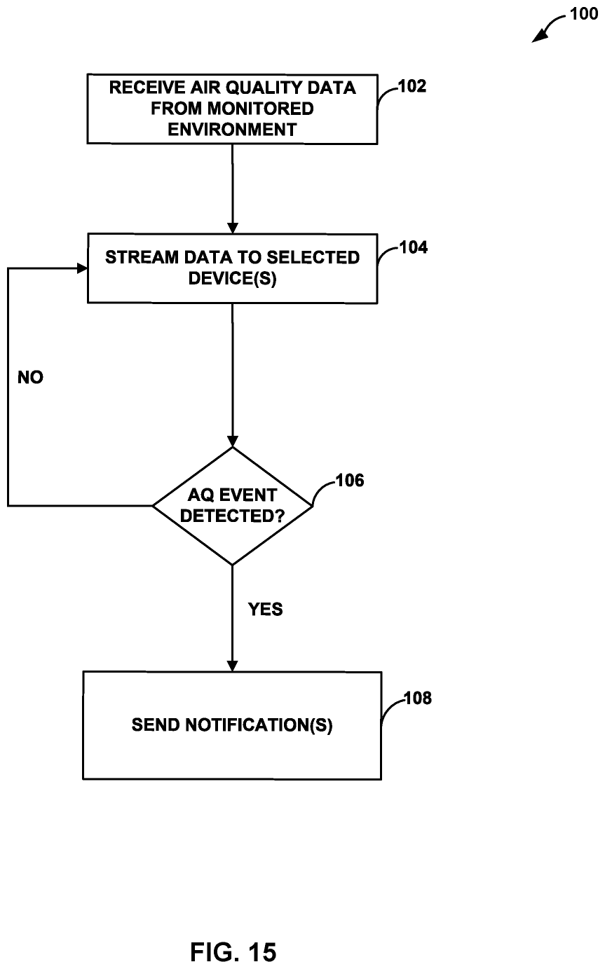

FIG. 15 is a flowchart illustrating a process 100 that AQMS 6 may perform in accordance with aspects of this disclosure. Process 100 may begin with AQMS 6 receiving air quality data from a monitored environment (102). For instance, AQMS 6 may receive air quality data pertaining to environment 8A from sensors 21. In turn, AQMS 6 may stream the air quality data to selected one or more devices (104). For instance, AQMS 6 may stream the data to those devices of computing devices 18 that have streaming services activated.

AQMS 6 may determine whether or not an AQ event has been detected (decision block 106). An example of an AQ event may be the crossing of one threshold or multiple thresholds, as discussed above and in additional detail below. If an AQ event has not been detected (NO branch of decision block 106), AQMS 6 may continue to stream the received air quality data to the selected one or more devices of computing devices 18 (thereby returning to step 104). However, if AQMS 6 determines that an AQ event has been detected (YES branch of decision block 106), AQMS 6 may send notification(s) to one or more of computing devices 18 (108). For instance, AQMS 6 may invoke notification service 40D for the notification functionality described above. AQMS 6 may also display the values, or may make the values available for display to end users, whether or not notifications are also made.

In various examples, in AQMS 6 determines AQ events using an algorithm that analyzes all incoming data. In these examples, HMS 32 may perform reactionary actions, such as changing the in level and/or causing LED blinking to locally alert to a potential event and switch to the faster data rate. In these examples, once AQMS 6 calculates the degree of the event, the local LED may change to the appropriate color level and/or blinking pattern, and AQMS 6 may alert users via remote computing devices 18 (e.g., via a mobile device included therein). If the respective remote user 24 opens the app, the respective remote computing device 18 may signal AQMS 6 to send a signal to HMS 32 to switch to a faster data rate so that the local device indicator and the app indicator become time synchronized showing the same AQ event level.

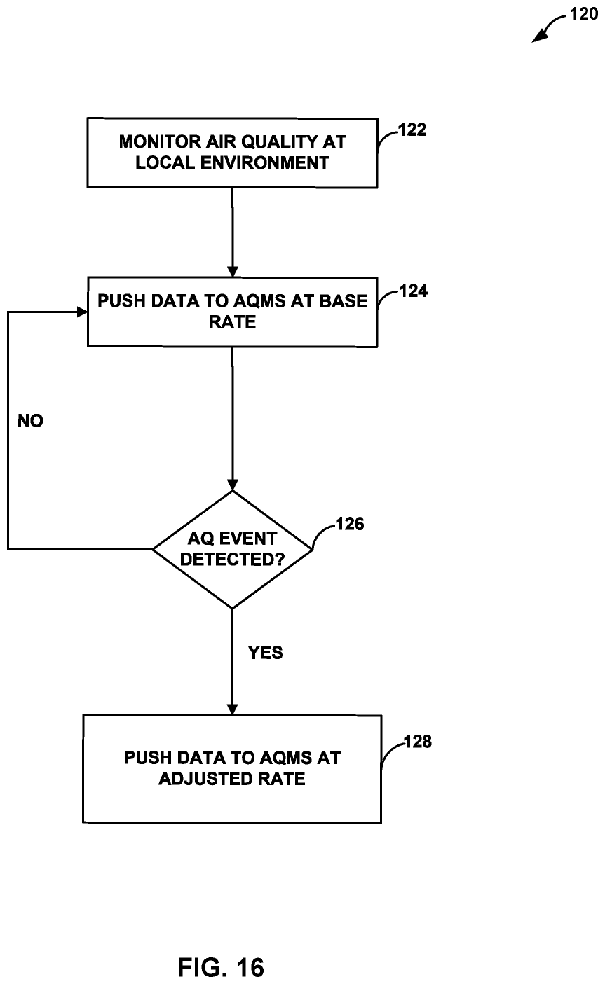

FIG. 16 is a flowchart illustrating a process 120 that sensors 21 and/or processing circuitry thereof or coupled thereto may perform in accordance with aspects of this disclosure. Process 120 is described with respect to sensors 21 of FIG. 1 and HMS 32 of FIG. 2. Process 120 may begin with sensors 21 monitoring air quality at a local environment, such as environment 8A (122). In turn, HMS 32 may push data to AQMS 6 at a base rate (124). In one example, the base rate is one push per minute. In turn, HMS 32 may determine whether the air quality has crossed a threshold level has been crossed representing a change in air quality at environment 8A (decision block 126). For instance, HMS 32 may determine whether the air quality has crossed a threshold level, thereby representing a change in air quality that qualifies as an AQ event. (In general, HMS 32 may implement an adjustable data push rate for a variety of reasons. For example, the adjustable data push rate may provide cost savings by reducing bandwidth usage when a higher push rate is not required. As another example, the adjustable push rate may provide a more efficient use of infrastructure and memory, and possibly a more robust system as a result. In some implementations, the adjustable data push rate represents an ‘intelligent’ system, in that the data push rate may be adjusted in a way that is responsive to context. In addition to cost and/or resource efficiency, different service levels or use cases may dictate higher or lower fidelity data capture, e.g., there might be a benefit to offering different service levels from a business perspective as well. A such, the adjustable data push rates of this disclosure may be beneficial for several reasons.

If an AQ event has not been detected, e.g., if the air quality has not crossed the threshold (NO branch of decision block 126), HMS 32 may continue to push the data to AQMS 6 at the base rate (thereby returning to step 124). However, if HMS 32 determines that a threshold has been crossed (YES branch of decision block 126), HMS 32 may push the data to AQMS 6 at an adjusted rate (128). HMS 32 may also trigger a local indicator, e.g., by initiating a blinking of a status indicator LED. In this case, AQMS 6 may examine the data received at the adjusted rate to determine whether an AQ event has been detected and may communicate data back to HMS 32 to continue the adjusted rate and change the indicator color to a representative color or blink pattern to indicate the degree of the AQ event. The adjusted rate is different from the base rate. For instance, if the AQ event represents a deterioration of air quality at environment 8A, AQMS 6 may set the adjusted rate to be faster than the base rate (e.g., one push every 30 seconds). Conversely, if the AQ event represents an improvement of the air quality at environment 8A, AQMS 6 may set the adjusted rate to be slower than the base rate (e.g., one push every two minutes).

FIG. 17 is a tree diagram illustrating various actions that AQMS 6 may implement based on the air quality level at environments 8. An example of a product recommendation that AQMS 6 may provide is to switch to a higher filtration level (e.g., by way of changing to a higher-precision or more granular air filter). Examples of comparison data that AQMS 6 may provide are comparisons to neighbors (e.g., neighboring homes or commercial buildings), comparisons to neighborhoods (e.g., an average air quality of the local neighborhood or a nearby neighborhood), comparisons to various regions of the country, etc. Table 1 below illustrates one example of air quality categorization that AQMS 6 may implement based on the levels of PM that has a particle size of 2.5 microns or below (i.e., PM_{2.5}), and/or based on the levels of ultrafine PM contamination in the air (“UFP”). Each category is also associated with a score range (indoor air quality score).

One exemplary method for determining a score range rests on reported and/or estimated impact of incremental PM_{2.5} and UFP exposure on human mortality. Certain research generally shows that for every increase in 10 μg/m³ the all-cause mortality would increase by 6% with long term exposure to PM_{2.5} (See e.g., Arden Pope III, et. al., “Lung Cancer, Cardiopulmonary Mortality, and Long-term Exposure to Fine Particulate Air Pollution” JAMAI, Mar. 6, 2002-Vol 287, No 9). Others have estimated that for every decrease of 1,000 particles/cm³ in ultrafine particles the all-cause mortality would decrease by 0.43% (See Hoek, G. et. al. “Concentration Response Functions for Ultrafine Particles and All-Cause Mortality and Hospital Admissions: Results of a European Expert Panel Elicitation” Environ. Sci. Technol. 2010, 40, 476-482).

A relationship between PM_{2.5} exposure and mortality may accordingly be represented by Equation 1, where p_{2.5} equals the percent increase in all-cause mortality due to exposure of incremental increase in PM_{2.5} by 10 μg/m³ and y is variable all-cause mortality.

$$P {M}_{2.5} = 10 μg / {m}^{3} * \frac{y}{{p}_{2.5}} \qquad Equation 1$$

Similarly, a relationship between UFP exposure and mortality may be represented by Equation 2, where p_{ufp} equals the percent increase or decrease in all-cause mortality due to the exposure of incremental increase of UFPs by 1000 particles/cm³ and y is variable all-cause mortality.

$$UFP = 1000 particles / {cm}^{3} * \frac{γ}{{p}_{UFP}} \qquad Equation 2$$

Exposure limits of UFP can then be determined based on known exposure limits of PM_{2.5} and a correlation between the all-cause mortality of each particulate type. This can be accomplished according to Equation 3, which defines UFP exposure limits as a function of PM_{2.5} particulate level.

$$UFP = 1000 particles / {cm}^{3} \frac{P {M}_{2.5}}{10 μg / {m}^{3}} * \frac{p 2.5}{pufp} \qquad Equation 3$$

Alternatively, the UFP exposure limits can be defined by creating variables for the ratio of particulate increase to the percentage increase in all-cause mortality. Where ρ is the ratio of PM_{2.5} (in μg/m³) to percent increase in all-cause mortality due to exposure of PM_{2.5} (Equation 4), and where φ is the ratio of UFP (in particles/cm³) to percent increase in all-cause mortality due to exposure of UFP (Equation 5).

PM_{2.5}=β*y Equation 4

UFP=φ*y Equation 5

The UFP Air Quality Index exemplified in Table 1 is premised on a p_{2.5} of 6% and a p_{ufp} of 0.43%.

TABLE 1

| | PM2.5 | PM2.5 Air | UFP | UFP Air |
|---|---|---|---|---|
| Level | (μg/m³) | Quality Index | (particles/cm³) | Quality Index |
| Very Good | 0-12 | 0-100 | 0-16744 | 0-100 |
| Good | 13-35 | 101-200 | 16745-48837 | 101-200 |
| Moderate/ | 36-50 | 201-300 | 48838-69767 | 201-300 |
| Fair | | | | |
| Poor | 51-1500 | 301-400 | 69768-209302 | 301-400 |
| Very Poor | 151-500 | 401-500 | 209303-697674 | 401-500 |
| Very Poor | 501-99999 | 500 | 697675- | 500 |
| | | | 999999999 | |

AQMS 6 may report the air quality index with the largest value as the overall air quality score and dictate the LED colors and/or blink patterns. In some examples, AQMS 6 may acquire outdoor PM2.5 data and compare to the indoor PM2.5 data to the acquired outdoor PM2.5 data to determine whether to send a notification to remote computing devices 18 to suggest closing a window or to suggest other actions.

Devices and systems of this disclosure may include, in addition to processors or processing circuitry, various types of memory. Memory devices or components of this disclosure may include a computer-readable storage medium or computer-readable storage device. In some examples, the memory includes one or more of a short-term memory or a long-term memory. The memory may include, for example, RAM, DRAM, SRAM, magnetic discs, optical discs, flash memories, or forms of EPROM, or EEPROM. In some examples, the memory is used to store program instructions for execution by processors or processing circuitry communicatively coupled thereto. The memory may be used by software or applications running on various devices or systems to temporarily store information during program execution.

If implemented in software, the techniques may be realized at least in part by a computer-readable medium comprising instructions that, when executed in a processor, performs one or more of the methods described above. The computer-readable medium may comprise a tangible computer-readable storage medium and may form part of a computer program product, which may include packaging materials. The computer-readable storage medium may comprise random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The computer-readable storage medium may also comprise a non-volatile storage device, such as a hard-disk, magnetic tape, a compact disk (CD), digital versatile disk (DVD), Blu-ray disk, holographic data storage media, or other non-volatile storage device.

The term “processor,” as used herein may refer to any of the foregoing structure or any other structure suitable for implementation of the techniques described herein. In addition, in some aspects, the functionality described herein may be provided within dedicated software modules or hardware modules configured for performing the techniques of this disclosure. Even if implemented in software, the techniques may use hardware such as a processor to execute the software, and a memory to store the software. In any such cases, the computers described herein may define a specific machine that is capable of executing the specific functions described herein. Also, the techniques could be fully implemented in one or more circuits or logic elements, which could also be considered a processor.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor”, as used may refer to any of the foregoing structure or any other structure suitable for implementation of the techniques described. In addition, in some aspects, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

It is to be recognized that depending on the example, certain acts or events of any of the methods described herein can be performed in a different sequence, may be added, merged, or left out altogether (e.g., not all described acts or events are necessary for the practice of the method). Moreover, in certain examples, acts or events may be performed concurrently, e.g., through multi-threaded processing, interrupt processing, or multiple processors, rather than sequentially.

In some examples, a computer-readable storage medium includes a non-transitory medium. The term “non-transitory” indicates, in some examples, that the storage medium is not embodied in a carrier wave or a propagated signal. In certain examples, a non-transitory storage medium stores data that can, over time, change (e.g., in RAM or cache).

Various examples have been described. These and other examples are within the scope of the following claims.

1. A device comprising:
a housing comprising a proximal end and a distal end, wherein the housing defines a longitudinal axis from the proximal end to the distal end;
a light source disposed near the proximal end of the housing configured to emit a beam of light along the longitudinal axis toward the distal end of the housing;
a fan configured to move air through the housing in a direction substantially opposite to the longitudinal axis; and
at least one optical sensor attached to the housing and configured to detect scattered light from the beam of light, wherein the at least one optical sensor is oriented to detect the scattered light at a first angle of less than 90 degrees from the longitudinal axis.

2. The device of claim 1, wherein the first angle is determined based on a first particle size to be detected by the at least one sensor.

3. The device of claim 1, wherein the first angle is between 25 degrees and 35 degrees.

4. The device of claim 1, wherein the first angle is between 15 degrees and 45 degrees.

5. The device of claim 4, wherein the first angle is 30 degrees.

6. The device of claim 1, wherein the first angle is between 55 degrees and 65 degrees.

7. The device of claim 1, wherein the first angle is 30 degrees, and further comprising:
a second optical sensor disposed at a second angle of 60 degrees from the distal end of the housing.

8. The device of claim 1, wherein the housing defines an air intake port and an exhaust port.

9. The device of claim 8, wherein the fan contributes to an airflow from the intake port to the exhaust port.

10. The device of claim 9, wherein the intake port is disposed between the exhaust port and the distal end.

11. The device of claim 1, further comprising a sensing circuit configured to receive data from the at least one optical sensor, wherein the sensing circuit comprises processing circuitry configured to determine an amount of particulate matter in response to receiving data from the at least one optical sensor.

12. The device of claim 11, wherein the sensing circuit is configured to generate an alert in response to determining a threshold amount of particulate matter.

13. The device of claim 1, further comprising a controller configured to vary at least one of the first angle and a wavelength of the beam of light.

14. A device comprising:
a housing having a distal end and a proximal end;
a light source disposed within the proximal end of the housing configured to direct a beam of light toward the distal end of the housing;
a fan configured to draw air through the housing in a direction away from the distal end;
at least one optical sensor attached to the housing and configured to detect scattered light from the beam of light; and
a light trap disposed at the distal end of the housing.

15. The device of claim 14, wherein the light trap is configured to direct the light away from the housing.

16. The device of claim 15, wherein the light trap comprises at least one 45-degree facet.

17. The device of claim 16, wherein the light trap comprises two 45-degree facets.

18. The device of claim 14, wherein the light trap comprises a rounded conical taper or a multi-sided conical taper.

19. The device of claim 14, wherein the light trap comprises a substantially dark material.

20. The device of claim 14, wherein the light trap comprises a substantially smooth surface finish.
